(19) United States
(12) Patent Application Publication
(10) Pub. No.: US 2022/0080499 A1
(43) Pub. Date: Mar. 17, 2022

(54) STIRRING DEVICE FOR A SEMI-SOLID METAL SLURRY AND METHOD AND SYSTEM FOR PRODUCING A SEMI-SOLID METAL SLURRY USING SUCH A STIRRING DEVICE

(71) Applicant: PA INVEST AB, Skillingaryd (SE)

(72) Inventor: Per JANSSON, Skillingaryd (SE)

(73) Assignee: PA INVEST AB, Skillingaryd (SE)

(21) Appl. No.: 17/416,783

(22) PCT Filed: Nov. 28, 2019
(86) PCT No.: PCT/SE2019/051207

§ 371 Date: Jun. 21, 2021

(30) Foreign Application Priority Data
Dec. 21, 2018 (SE) 1851648-4

(51) Int. Cl. B22D 41/62

(52) U.S. Cl. CPC B22D 41/62

(57) ABSTRACT

A stirring device to be used for stirring a semi-solid metal slurry, wherein the stirring device is to rotate around a rotational axis (X-X) when used for stirring a semisolid metal slurry. The stirring device includes an elongated shaft extending along the rotational axis (X-X), and at least two wings securely arranged to the elongated shaft and extending radially outwards from the elongated shaft, wherein the at least two wings also have a substantial axial extension along the rotational axis (X-X). Hereby, whirls are produced in the slurry that results in a well-homogenized slurry with no large metal oxide surfaces inside. Disclosed is also a production method and a system for producing the slurry.

### TECHNICAL FIELD

The present disclosure relates generally to processes for producing a semi-solid metal slurry. More specifically, the present disclosure relates to a stirring device for a slurry-producing process and a slurry-producing process comprising such a stirring device.

### BACKGROUND

It is well-known to produce details and components of metal by casting using a metal of semi-solid form, aka liquid-solid form, i.e. a material that when casted contains a mixture of the metal in liquid state and the metal in solid state. The metal in solid state in such a mixture is preferably in the shape of small particles. Such a material is called a semi-solid metal slurry. The metal in the slurry can be a pure metal of one and the same atomic number or an alloy of different metals.

When comparing casting details from liquid metal to casting details from a semi-solid metal slurry, the details made from a semi-solid metal slurry often have less defects and better mechanical characteristics. Also, the semi-solid metal slurry is much easier to handle than the liquid metal. For example, the semi-solid metal slurry solidifies more slowly than the liquid metal, which makes it easier to change the shape of a detail made from a semi-solid metal slurry during the solidification procedure than to change the shape of a detail made from liquid metal. For the same reason, traditional casting, from a liquid metal, needs to be made quickly, before the material solidifies. For example in die casting, a quick pressing gives air bubbles inside the casted details, which results in details with less quality. When die casting is performed from a semi-solid metal slurry, the die casting can be made more slowly resulting in less air bubbles. Casting from a semi-solid metal slurry is therefore very suitable for critical details that are exposed to high strains and therefore need to be of high quality.

In the European granted patent EP 1838885 B1 a method and a device for producing such a semi-solid metal slurry is described. This method is based upon the idea of adding a defined amount of solid metal to a defined amount of liquid metal. The solid metal would then at least partly be melted by the liquid metal and a semi-solid metal slurry is created. In order to get a good mixture of solid particles in the liquid material and to suppress generation of a dendritic network in the slurry, the mixture of solid and liquid material is stirred until the solid metal has melted into the liquid metal. Compared to older solutions in which metal in liquid-shape was cooled using external cooling until it became semi-solid, this process rather uses “internal cooling”, i.e. cooling from the solid metal part. EP 1838885 B1 further suggests using a mechanical stirrer for performing the stirring. Onto the mechanical stirrer, solid metal is welded, or the solid metal could be supplied into the melt through the stirrers via a channel extending through the stirrers. Such arrangements seem complicated and will certainly not be suitable for large-scale production of products, i.e. for serial production in which the slurry needs to be refilled.

The present applicant then developed a method for producing a semi-solid slurry that is useable in larger scale, which method is described patented in the Swedish patent SE 538596. In this method, the solid metal provided to the mechanical stirrer is provided by inserting a mechanical stirrer into a mould, which has an inner shape similar to the size of the mechanical stirrer provided with the solid metal. After the mechanical stirrer has been inserted into the mould, liquid metal is poured into the mould. After some time in the mould, the liquid metal has solidified and fastened onto the stirrer. Such a way of providing the solid metal is much easier and more time-efficient than the way of welding as described in EP1838885.

When handling metal in liquid form, most metal sorts, pure metals and alloys, oxidize if exposed to oxygen. For example, when casting products of Aluminum, liquid Aluminum exposed to oxygen will oxidize very quickly. Aluminum oxide is experienced as dry. Two surfaces of aluminum oxide that are pushed towards each other will not become one unit. In other words, when a metal slurry comprises larger surfaces of aluminum oxide when poured into a casting machine, the produced products may have weaker areas at the aluminum oxide layers. Even though the products produced by the method described in the above prior art patent applications are high-end products, it would be of interest to produced even better products by reducing the areas of metal oxides such as aluminum oxides produced from semi-solid metal slurries.

### SUMMARY

It is an object of the invention to address at least some of the problems and issues outlined above. An object of embodiments of the invention is to provide a way of reducing metal oxide areas in products produced from semi-solid metal slurries. Another object is to provide a semi-solid metal slurry that has a substantially same viscosity throughout the slurry. It is possible to achieve these objects and others by using stirring devices and slurry-producing processes as defined in the attached independent claims.

According to one aspect, a stirring device to be used for stirring a semi-solid metal slurry is provided. When used for stirring a semisolid metal slurry, the stirring device rotates around a rotational axis. The stirring device comprises an elongated shaft extending along the rotational axis, and at least two wings securely arranged to the elongated shaft and extending radially outwards from the elongated shaft, wherein the at least two wings also have a substantial axial extension along the rotational axis, the axial extension of the wings at the elongated shaft being at least 15% of a total length of the elongated shaft. By having wings that extend radially outwardly and also have such a substantial extension along the rotational axis, whirls are created in the semi-solid metal slurry that creates a movement throughout the semi-solid metal slurry which results in a good homogenization in the slurry as well as destroying of any larger continuous metal oxide layers. When rotating the shaft having wings with such an axial length, a shearing force is applied to in the slurry that creates the good homogenization and destroys any upcoming metal oxide layers in the slurry.

According to an embodiment, the axial extension of the wings at the elongated shaft is at least 25% of the total length of the elongated shaft, more preferably at least 35%.

According to another embodiment, the at least two wings are tapered axially in a direction radially outwards from the elongated shaft. By making the wings taper radially outwardly, they have proven to have better structural strength when being rotated in the slurry compared to wings that have the same axial length in a direction radially outwardly.

According to another embodiment, the elongated shaft has a first end adapted to be inserted into a rotation-providing machine and a second end distal to the first end, and wherein the at least two wings are arranged at the second end. Hereby it is secured that the wings can be below a surface of the slurry when the stirring is performed.

According to another aspect, a method for producing a semi-solid metal slurry is provided. The method comprises pouring metal in liquid form into a mould in which an elongated device is introduced, and keeping the elongated device in the mould until the metal has been casted to the elongated device. The method further comprises leading the elongated device with metal casted onto it from the mould into a vessel comprising metal in liquid form, and after the elongated device has been led into the vessel comprising the metal in liquid form, stirring in the vessel using a stirring device according to the above aspect at least until a majority of the metal casted onto the elongated device has fallen off the elongated device and into the vessel so that a semi-solid metal slurry is produced.

According to another aspect, a system is provided for producing a semi-solid metal slurry. The system comprises a first arrangement having at least one elongated device and a mould. The first arrangement is configured to introduce one of the at least one elongated devices into the mould. The system further comprises a second arrangement for pouring melted metal into the mould. The first arrangement is further configured to keep the one elongated device in the mould until the metal has been casted to the one elongated device, and to lead the one elongated device with metal casted onto it into a vessel comprising metal in liquid form. The system further comprises a stirring device according to the above aspect for stirring in the vessel, after the one elongated device has been led into the vessel comprising metal in liquid form, at least until a majority of the metal casted onto the one elongated device has fallen off the one elongated device and into the vessel so that a semi-solid metal slurry is produced.

According to an embodiment, the stirring device is the one elongated device that has been led into the vessel. An advantage by using one and the same device as elongated device and as stirring device is that the surface of the slurry only needs to be broken for one device instead of for two devices.

According to another embodiment, the stirring device is a separate device arranged separate from the one elongated device. A separate stirring device may be simpler and hereby more cost-efficient to produce compared to one device used as both stirring device and elongated device.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a system for producing a semi-solid metal slurry according to embodiments of the invention.

FIG. 2a is a side view of a stirring device to be used for stirring a semi-solid metal slurry, according to embodiments of the invention.

FIG. 2b is a view from above of the stirring device of FIG. 2a.

FIG. 3 is a flow chart of a method for producing a semi-solid metal slurry according to embodiments.

### DETAILED DESCRIPTION

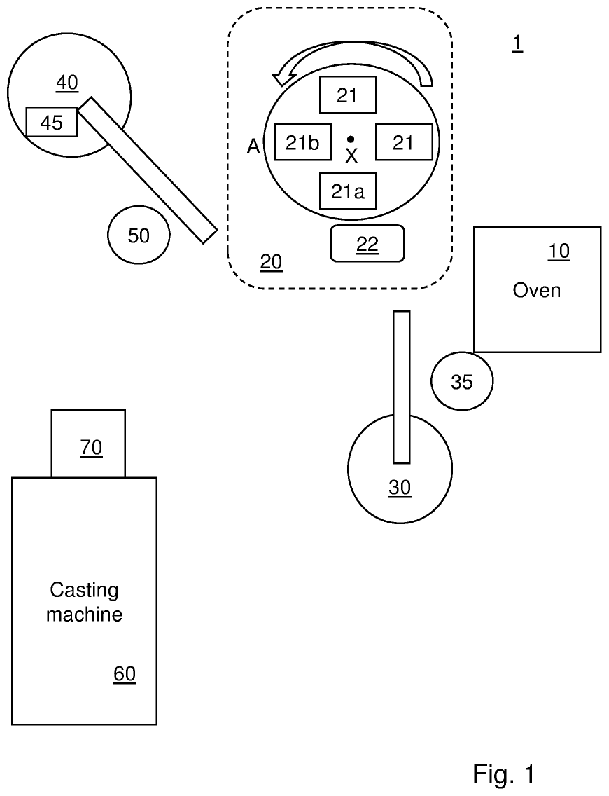

As described in the background, it is an object of embodiments of the invention to provide a way of reducing metal oxide areas in products produced from semi-solid metal slurries. When looking into this problem, the inventor has found out that the metal slurry needs to be stirred in a more efficient way than what is done with today's metal slurry producing processes and stirring devices. The stirring device shown in EP1838885 has a vertical rotation axle onto which horizontally extending pins are arranged at the lower end of the vertical rotation axle. As can be seen in FIG. 1 of EP1838885, the pins mainly has a horizontal extension. The stirring provided in the slurry is hereby mainly performed around the small pins and along the vertical rotation axle. Whirls resulting from the stirring using the prior art mechanical stirring device do not reach far out from the pins. Consequently, metal oxide areas that have been developed during the slurry-producing process may still be in the slurry. In addition, when using the prior art mechanical stirrers, the slurry that is poured out tends not to be as homogenous regarding amount of solid particles contra liquid metal as would have been desired. In other words, there are parts of the slurry that has higher viscosity than other parts. As a result, when the slurry is poured out into a filling chamber of a casting machine, the part that is poured out first tends to have the highest viscosity and the viscosity decreases the less slurry that is left in the container where the stirring took part. As the material having the highest viscosity also is closest to being pure liquid, it solidifies more quickly than the parts having lower viscosity. There is then a risk that some of this metal with the lowest viscosity cools and solidifies when coming into contact with the filling chamber. This may eventually result in parts of the casted products not sitting as tight together as required.

In order to avoid the problem occurring from different viscosity in different parts of the produced slurry and in order to avoid the problem of areas of metal oxide layers in the slurry, another type of stirring device has been developed. This type of stirring device has wings that, except from extending radially from the vertically positioned shaft, as the pins of the stirring device of EP1838885, also has a substantial vertical extension along the vertical shaft. By the wings of the inventive stirring device having an extension both radially but also a substantial vertical extension, a better stirring is achieved in the slurry compared to in the prior art. Hereby, the whirls created by the stirring to a larger extent reaches through the whole slurry. As a result, the produced slurry is better homogenized than the slurry produced using the prior art stirring device. Also, any larger metal oxide layers that may exist in the slurry are destroyed through the better stirring produced from the inventive stirring device.

FIG. 1 shows an embodiment of a system 1 for producing a semi-solid metal slurry. The system comprises an oven 10 for melting metal to be used in the process of producing the semi-solid metal slurry. The metal of the semi-solid metal slurry may be any metal or alloy of metals. The oven 10 may be any kind of oven used for melting metal, i.e. for producing metal in liquid form. According to an advantageous embodiment, the oven 10 may have an open bath in which melted metal is kept, so that it is easy to take up liquid metal from the bath to be used in the system 1. In order to avoid oxidation there may be a heavy gas such as Nitrogen or Helium arranged on the surface of the liquid metal, a gas that will not react with the liquid metal. Further, the bath may be rather deep, i.e. have a delimited volume above the surface so that the heavy gas remains above the metal liquid surface. The oven 10 may further have a thermostat for keeping the melted metal at a rather constant temperature selected for achieving a good result in the slurry-producing process.

The system 1 further comprises a first arrangement 20 for handling at least one elongated device 21 onto which metal are to be casted. The first arrangement 20 further has a mould 22. The system 1 further comprises a second arrangement 30 for taking up liquid metal from the oven 10 and pouring it into the mould 22. The second arrangement may be a robot 30. The robot 30 may for example have one moveable arm that may be moveable in one joint. The arrangement 30 may have a container 35, such as a bucket, for taking up the liquid metal from the oven 10 and pouring it into the mould 22. In order to avoid that the container 35 as such cools the liquid metal, the container may be pre-warmed by holding it in the liquid metal in the oven 10 before it is used for taking up metal from the oven. The second arrangement 30 is further arranged to move the container 35 filled with the liquid metal towards the first arrangement 20 and to pour the liquid metal into the mould 22. When the liquid metal is poured into the mould 22, a first 21a of the at least one elongated devices 21 is already inserted into the mould. Alternatively, the first elongated device 21a may be inserted into the mould 22 after the liquid metal has been poured into the mould 22. The size of the mould 22 is adapted so that when the elongated device 21 is inserted and metal is poured over the mould 22 a defined amount of metal will be in the mould, comprising the amount of solid metal you would like to insert into the slurry.

According to a certain embodiment, the first arrangement 20 may have a plurality of different units, in the example of FIG. 1 four units, each unit holding one elongated device 21. The elongated devices 21 are rotated stepwise by the first arrangement 20 around a rotational axis X, for example in the direction of the arrow of FIG. 1 so that one elongated device at a step is inserted into the mould 22 and poured over with liquid metal. After the first elongated device 21a has been inserted into the mould 22 and liquid metal has been poured into the mould 22 by the second arrangement 30, the first elongated device 21a is kept in the mould a defined time until the liquid metal has solidified. After the defined time has elapsed, the elongated devices are rotated one more step so that the first elongated device is taken out of the mould and a second elongated device 21b is inserted into the mould, where after liquid metal from the oven 10 is poured into the mould etc.

When the first elongated device 21a has been rotated a step after it was in the mould 22, the first arrangement 20 controls that there is a correct amount of solid metal casted onto the device 21a. Thereafter, one or more steps in the rotation process are used for cooling the solid metal casted onto the device to a correct temperature for producing a semi-solid metal slurry. After the first device 21a has been rotated some steps by the first arrangement 20, in the example of FIG. 1, three steps, the first device 21a should have a suitable amount of solid metal casted onto it, the solid metal having a suitable temperature for producing a semi-solid metal slurry.

While metal is casted onto an elongated device 21, a third arrangement 40 fills an open vessel 50 with a predefined amount of liquid metal from e.g. the oven 10 and moves the open vessel 50 towards the first arrangement 20. The third arrangement 40 may be a robot. As the first elongated device 21a has been rotated a couple of steps and reached a predefined position, in the example of FIG. 1 three steps from the casting in the mould so that it has reached position A when the first device is ready for being used in the producing of the slurry, the third arrangement 40 moves the open vessel 50 towards the predefined position. More precisely, the open vessel 50 is moved so that the first elongated device 21a is put down into the liquid metal in the open vessel 50. The first elongated device 21a is then kept in the vessel 50 until the metal casted onto the first elongated device 21a has fallen into the vessel 50 and a semi-solid metal slurry has been created. During the process of keeping the first elongated device 21a in the vessel 50, a stirring device is rotated in the vessel in order to stir the mixture of solid and liquid metal. The stirring in the vessel 50 is performed at least until a majority of the metal casted onto the first elongated device 21a has fallen off the first elongated device 21a and into the vessel 50 so that a semi-solid metal slurry is produced.

Then the vessel 50 with the produced semi-solid metal slurry is moved by the third arrangement 40 to a filling chamber 70 of a casting machine 60, and the semi-solid metal slurry is poured into the filing chamber 70. According to an embodiment, the stirring is performed right until the slurry is poured into the filling chamber.

As the production is performed in steps, when the metal casted onto the first elongated device 21a has fallen off the first elongated device, the first elongated device 21a continues its rotational movement stepwise. The first elongated device 21a may now be cleaned from possible additional solid metal before it is ready to be used in the mould again, and undergo the same procedure again with casting in the mould, cooling, putting down into the vessel 50 with liquid metal and back to the moulding after the casted metal has fallen off the first elongated device and into the vessel 50. During the described process of the first elongated device 21a, the second elongated device 21b undergoes the same procedure, just one step after the first elongated device, and subsequent elongated devices 21 follows one or more steps later than the second elongated device 21b.

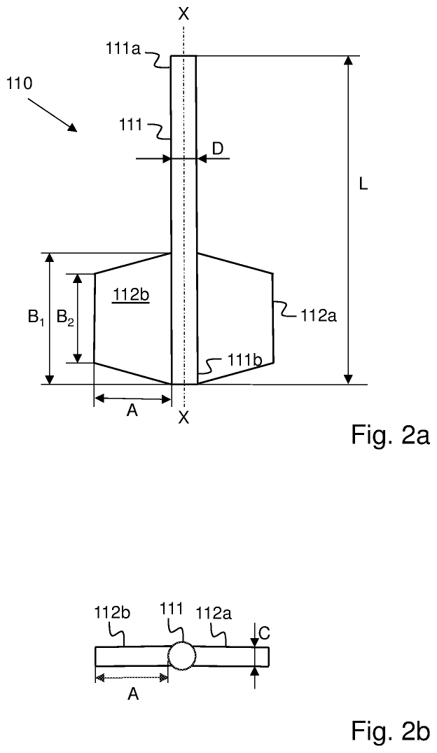

In the following, an embodiment of a stirring device 110 according to the invention is described with reference to FIGS. 2a and 2b. According to a first embodiment, the stirring device 110 is the actual elongated device 21 of FIG. 1. In other words, the elongated devices 21, including the first and second elongated devices 21a, 21b, are also used as stirring devices 110. According to a second embodiment, the stirring device 110 is a device separate from the elongated devices 21, such as a device 45 (FIG. 1) controlled by the third arrangement 40. In this second embodiment, the stirring device 110 is put down into the open vessel 50 during the production of the slurry, i.e. the stirring device 110 is then at least partly in the slurry at the same time as the respective elongated device 21 is there.

The stirring device 110 according to the embodiment of FIGS. 2a and 2b comprises an elongated shaft 111 having a first end 111a and a second end 111b distal to the first end. The first end 111a is arranged for insertion into a rotation-providing machine, such as the third arrangement 40. The elongated shaft 111 extends along an axis X-X, which also functions as a rotational axis when the stirring device 110 is rotated by the third arrangement 40. The elongated shaft has a circular cross section with a diameter D. However, other cross-sectional forms may apply, such as a quadratic cross-section. The elongated shaft has a length L along the axis X-X.

The stirring device 110 further comprises wings 112a, 112b, preferably arranged at the second end 111b of the shaft. The wings 112a, 112b extend radially outwards from the elongated shaft 111. “Extending radially outwards” signifies extending in a radial direction compared to the rotational axis X-X. i.e. extending perpendicular to the rotational axis X-X. In the embodiment of FIGS. 2a and 2b, there are two wings that extend in opposite directions. However, in other embodiments there may be more than two wings, such as three or four wings or even more wings. The wings are then preferably spread out evenly around the elongated shaft. The wings 112a, 112b also have a substantial extension along the elongated shaft, also called axial extension. For example, the wings 112a, 112b have an axial extension that is at least 10% of the total length L of the shaft, more preferably at least 15%, more preferably at least 20%, and most preferably at least 25%. According to another example, the wings have an axial extension of at least 20 mm. According to another example, the wings 112a, 112b have an axial extension that is adapted to a depth which the stirring device 110 is to be inserted into the liquid metal in the vessel. The axial extension of the wings may be 30-70% of the depth the stirring device is to be inserted into the liquid metal. This means that when the wings extend to the distal end 111b of the shaft, the wings end so that about 30-70% of the elongated shaft that is below a surface of the liquid metal is not equipped with wings. Hereby, a suitable shearing force is achieved on the slurry.

According to an embodiment, the wings 112a, 112b are tapered axially in a direction radially outwardly from the shaft 111. In other words, the wings each has a first axial extension B₁ at the shaft 111 and a second axial extension B₂ at its end distal from the shaft, wherein B₂<B₁. According to an embodiment, the first axial extension B₁ is at least 15% of the total length, more preferably at least 25%, more preferably at least 35% and most preferably at least 40% of the total length L of the shaft. According to another embodiment, the second axial extension B₂ is 5-30% less of the total length L than the first axial extension B₁, and the second axial extension B₂ is 25-45% shorter than the first axial extension B₁. The wings 112a, 112b further have a radial extension A and a thickness C in the angular direction, i.e. perpendicular to the radial direction. The thickness C may be less than half the radial extension A. The thickness C of each wing 112a, 112b may be the same along the radial extension, i.e. the thickness is the same at its end secured to the shaft 111 as at its end distal to the shaft. The thickness C may be smaller than the diameter D of the elongated shaft 111. For example, the thickness C may be 50-80% of the diameter D. The measures of A, B₁, B₂, C, D and L may be varied depending on the size of the slurries that are to be produced.

The stirring device 110 as well as the elongated devices 21 are made of a material that has a higher melting point than the melting point of the metal in the slurry. Further, the material of the elongated devices 21 as well as the stirring device 110 is made of a material that does not react with the metal in the slurry. The material may e.g. be stainless acid-resisting steel or a ceramic material or the stirring device may be coated with a ceramic material.

According to an embodiment, the at least two wings 112a, 112b each has a substantially same thickness along their radial extension.

According to another embodiment, the thickness of each of the at least two wings is smaller than a thickness of the elongated shaft.

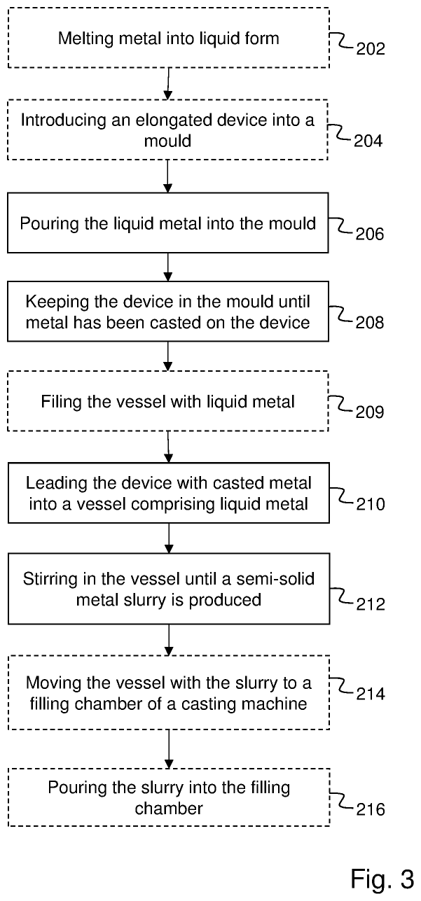

FIG. 3 describes an embodiment of a method for producing a semi-solid metal slurry. The method comprises pouring 206 metal in liquid form into a mould in which an elongated device is introduced and keeping 208 the elongated device in the mould until at least part of the metal in the mould has been casted to the elongated device. Thereafter, the elongated device with metal casted onto it is lead 210 from the mould into a vessel 50 (FIG. 1) comprising metal in liquid form, and a stirring device, for example as described in connection with FIG. 2, is used for stirring 212 in the vessel at least until a majority of the metal casted onto the elongated device has fallen off the elongated device and into the vessel so that a semi-solid metal slurry is produced.

According to an embodiment, the method may also comprise melting 202 metal into liquid form, for example in the oven 10 described in FIG. 1. This metal in liquid form is then used for filling 206 the mould.

Further, an elongated device 21 is introduced 204 into the mould. According to one embodiment, the introduction 204 is performed before the liquid metal is poured into the mould. According to another embodiment, the introduction 204 is performed after the liquid metal has been poured into the mould.

According to another embodiment, before the leading 210 of the elongated device from the mould and into the vessel, the vessel is filled 209 with metal in liquid form. This liquid metal may come from the oven 10 where it was melted 202.

According to another embodiment, the vessel with the produced semi-solid metal slurry is moved 214 to a filling chamber of a casting machine, and the semi-solid metal slurry is poured 216 into the filing chamber. The stirring may be performed while moving 214 the semi-solid metal slurry. The stirring may be performed right until the semi-solid slurry is poured 216 into the filling chamber.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” In the exemplary figures, a broken line generally signifies that the feature within the broken line is optional.

1. A stirring device to be used for stirring a semi-solid metal slurry, wherein the stirring device is to rotate around a rotational axis (X-X) when used for stirring a semisolid metal slurry, the stirring device comprising:
an elongated shaft extending along the rotational axis (X-X), and
at least two wings securely arranged to the elongated shaft and extending radially outwards from the elongated shaft, wherein the at least two wings also have a substantial axial extension along the rotational axis (X-X), the axial extension of the wings at the elongated shaft being at least 15% of a total length of the elongated shaft.

2. The stirring device according to claim 1, wherein the axial extension of the wings at the elongated shaft is at least 25%, more preferably at least 35% of the total length of the elongated shaft.

3. The stirring device according to claim 1, wherein the at least two wings are tapered axially in a direction radially outwards from the elongated shaft.

4. The stirring device according to claim 3, wherein the at least two wings each has a first axial extension at the shaft and a second axial extension at its end distal from the shaft, wherein the second axial extension is 25-45% shorter than the first axial extension.

5. The stirring device according to claim 1, wherein the elongated shaft has a first end adapted to be inserted into a rotation-providing machine and a second end distal to the first end, and wherein the at least two wings are arranged at the second end.

6. The stirring device according to claim 1, wherein the elongated shaft has a circular cross section.

7. The stirring device according to claim 1, wherein the at least two wings consists of two wings extending radially outwards from the elongated shaft in opposite directions.

8. The stirring device according to claim 1, arranged to be inserted into a semi-solid metal slurry so that the at least two wings are totally below a surface of the slurry and so that the axial extension of the at least two wings is 30-70% of a length of a part of the elongated shaft that is below the surface, when the stirring device is to be rotated.

9. A method for producing a semi-solid metal slurry, comprising:
pouring metal in liquid form into a mould in which an elongated device is introduced;
keeping the elongated device in the mould until the metal has been casted to the elongated device;
leading the elongated device with metal casted onto it from the mould into a vessel comprising metal in liquid form;
after the elongated device has been led into the vessel comprising the metal in liquid form, stirring in the vessel using a stirring device according to claim 1, at least until a majority of the metal casted onto the elongated device has fallen off the elongated device and into the vessel so that a semi-solid metal slurry is produced.

10. The method according to claim 9, further comprising:
moving the vessel with the produced semi-solid metal slurry to a filling chamber of a casting machine, while stirring in the vessel and
pouring the semi-solid metal slurry into the filing chamber.

11. A system for producing a semi-solid metal slurry, comprising:
a first arrangement having at least one elongated device and a mould, the first arrangement being configured to introduce one of the at least one elongated devices into the mould;
a second arrangement for pouring melted metal into the mould,
wherein the first arrangement is further configured to keep the one elongated device in the mould until the metal has been casted to the one elongated device, and to lead the one elongated device with metal casted onto it into a vessel comprising metal in liquid form,
a stirring device according to claim 1, for stirring in the vessel, after the one elongated device has been led into the vessel comprising metal in liquid form, at least until a majority of the metal casted onto the one elongated device has fallen off the one elongated device and into the vessel so that a semi-solid metal slurry is produced.

12. The system according to claim 11, wherein the stirring device is the one elongated device that has been led into the vessel.

13. The system according to claim 11, wherein the stirring device is a separate device arranged separate from the one elongated device.

14. The system according to claim 11, further comprising a third arrangement arranged for filing the vessel with metal in liquid form, for moving the vessel filled with metal in liquid form towards the one elongated device with metal casted onto it and for moving the vessel with the semi-solid metal slurry to a filling chamber of a casting machine and for pouring the semi-solid metal slurry into the filling chamber.
